(19) United States
(12) Patent Application Publication
(10) Pub. No.: US 2006/0053232 A1
(43) Pub. Date: Mar. 9, 2006

(54) Digital content distribution system, right management server and user terminal

(76) Inventors: Sen'ichi Onoda, Toyonaka-shi (JP); Katsumi Tokuda, Ikeda-shi (JP); Masaya Yamamoto, Hirakata-shi (JP); Kouji Miura, Matsubara-shi (JP)

Correspondence Address: WENDEROTH, LIND & PONACK, L.L.P., 2033 K STREET N. W., SUITE 800, WASHINGTON, DC, 20006-1021, US

(21) Appl. No.: 10/540,024

(22) PCT Filed: Mar. 9, 2004
(86) PCT No.: PCT/JP04/03038

§ 371 Date: Jun. 22, 2005

(30) Foreign Application Priority Data
Mar. 12, 2003 (JP) 2003-065852

(51) Int. Cl. G06F 15/16

(52) U.S. Cl. 709/246

(57) ABSTRACT

In a right management server (100), a license data generation/updating unit (307) generates license data (900) including a use condition (503) for permitting a user to use a content based on a content use right (500) owned by the user. A subset use condition setting unit (308) sets a subset use condition (901) for temporarily invalidating the license data (900) in the license data (900). A communication unit (311) transmits the license data (900) in which the subset use condition (901) is set to the user terminal (110), and receives the license data (900) returned from the user terminal (110). Upon receipt of the invalidated license data (900), the license data generation/updating unit (307) cancels the invalidation of the license data (900) by updating the subset use condition (901).

### TECHNICAL FIELD

The present invention relates to a digital content distribution system, and more specifically to a digital content distribution system that allows protection of rights concerning digital content data.

### BACKGROUND ART

Systems for distributing digital works such as music, video, game and the like via the Internet, digital broadcasting or the like have been developed in recent years, and some of them are in the stage of practical use. In keeping pace with the development of such content distribution systems, content use control techniques for controlling the number of reproductions, moving and copying of distributed contents are under consideration from the viewpoint of copyright protection.

In the conventional digital content distribution system, as disclosed in Japanese Laid-Open Patent Application No. 2000-48076, for example, a use condition of a content for each user as well as the content are distributed to the user terminal, and the user terminal manages the use of the content based on the distributed use condition.

Suppose, for example, that a user purchases a right to view a movie titled “EIGA” 3 times. The user terminal receives the use condition indicating that the user “can view the movie ‘EIGA’ 3 times” as well as the movie content itself from the distribution server, and manages the reproduction of the content according to this use condition. Every time the user views the content “EIGA” once on the user terminal, the user terminal performs the processing of subtracting 1 from the maximum number of views, that is the use condition under the management of the user terminal, and then performs the processing of canceling permission for the user to view it at the time when the maximum number of views becomes 0.

However, according to the existing techniques, the user does not need to access the server again because the user can use the content on the terminal as long as the use condition received on the user terminal is satisfied. Therefore, there is a problem that the server cannot obtain the information concerning the terminal such as history logs of the content at an arbitrary timing.

In view of the above problem, the first object of the present invention is to provide a mechanism for allowing the terminal to obtain all the use rights and the server to invalidate a part of the use rights or cancel the invalidation at an arbitrary timing before all the use rights are consumed. In addition, the second object of the present invention is, by use of the first mechanism, to provide a mechanism for causing the terminal to report the information accumulated in the terminal only, such as content history logs, at an arbitrary timing set by the server.

### DISCLOSURE OF INVENTION

In order to solve the above problem, the digital content distribution system of the present invention is a digital content distribution system comprising a right management server and a user terminal which are connected to each other via a communication network, said right management server issuing, to the user terminal, license information for permitting a user to use a content, and said user terminal using the content based on the license information obtained from the right management server, wherein the right management server includes: a first condition generation unit operable to generate a first condition based on a content use right owned by the user, said first condition being a condition for permitting the user to use the content; a second condition generation unit operable to generate a second condition that indicates a part or all of the use permitted under the first condition and indicates whether the license information is valid or invalid based on a logical product of the first condition and said second condition; a license generation unit operable to generate the license information including the first condition and the second condition in response to a license obtainment request from the user terminal; and a license issuance unit operable to issue the generated license information to the user terminal so that said user terminal obtains said license information, and the user terminal includes: a license obtainment requesting unit operable to request the right management server to issue the license information so as to obtain said license information; an invalidity judgment unit operable to judge whether the license information is invalid or not based on the first condition and the second condition included in the obtained license information; and a using unit operable to provide the use of the content to the user when it is judged that the license information is not invalid.

It is also possible that the user terminal further includes a license information returning unit operable to return the license information to the right management server when it is judged that the license information is invalid, and the right management server further includes: a return acceptance unit operable to accept, from the user terminal, return of the license information which is judged to be invalid; an invalidation cancellation unit operable to cancel invalidation of the license information by updating the second condition included in the returned license information to a new value; and a reissuance unit operable to reissue, to the user terminal, the license information of which invalidation is cancelled.

It is also possible that the user terminal further includes a history information storage unit operable to generate history information indicating a history of the use of the content when said content is used by the using unit, and store the generated history information, and the license information returning unit transmits the license information to be returned, together with the stored history information, to the right management server.

It is also possible that the second condition is represented by a subset of the first condition, said subset being either a maximum allowable number of uses which is not more than a maximum allowable number of uses indicated in the first condition or an expiry date which is earlier than an expiry date indicated in the first condition.

It is also possible that the license information includes at least a license information ID for identifying the license information, the first condition, the second condition and a content decryption key for decrypting an encrypted content which is permitted to be used based on the license information.

It is also possible that the invalidity judgment unit judges whether the license information is invalid or not every time power is applied to the user terminal.

The right management server of the present invention is a right management server connected with a user terminal via a communication network for issuing license information to the user terminal so that the user terminal obtains the license information, said license information permitting a user to use a content, and said server includes: a first condition generation unit operable to generate a first condition based on a content use right owned by the user, said first condition being a condition for permitting the user to use the content; a second condition generation unit operable to generate a second condition that indicates a part or all of the use permitted under the first condition and indicates whether the license information is valid or invalid based on a logical product of the first condition and said second condition; a license generation unit operable to generate the license information including the first condition and the second condition in response to a license obtainment request from the user terminal; and a license issuance unit operable to issue the generated license information to the user terminal so that said user terminal obtains said license information.

The user terminal of the present invention is a user terminal connected with a right management server via a communication network for obtaining license information from the right management server and using a content based on the obtained license information, said license information permitting a user to use the content, and said terminal includes: a license obtainment requesting unit operable to request the right management server to issue the license information so as to obtain said license information; an invalidity judgment unit operable to judge whether the license information is invalid or not based on a first condition and a second condition included in the obtained license information, said first condition being a condition for permitting the user to use the content based on a content use right owned by the user, said second condition indicating a part or all of the use permitted under the first condition and indicating whether the license information is valid or invalid based on a logical product of the first condition and said second condition; a using unit operable to provide the use of the content to the user when it is judged that the license information is not invalid; and a license information returning unit operable to return the license information to the right management server when it is judged that the license information is invalid.

As described above, the digital content distribution system of the present invention brings about the effect of allowing the server to collect the information concerning the user terminal, such as the content history logs, which is held by only the user terminal, at a timing determined by the server.

The present invention can be realized not only as the above-mentioned digital content distribution system, but also as a single unit such as a right management server and a user terminal included in this digital content distribution system, as a right management method including steps of characteristic operations executed in this digital content distribution system, or as a program for causing a general-purpose computer such as a personal computer to execute these characteristic operations. And it goes without saying that the program can be distributed via a computer readable recording medium such as a CD-ROM or a transmission medium such as the Internet.

As further information about technical background to this application, Japanese Laid-Open Patent Application No. 2003-065852 filed on Mar. 12, 2003 is incorporated herein by reference.

### BRIEF DESCRIPTION OF DRAWINGS

These and other objects, advantages and features of the invention will become apparent from the following description thereof taken in conjunction with the accompanying drawings that illustrate a specific embodiment of the invention. In the

### DRAWINGS

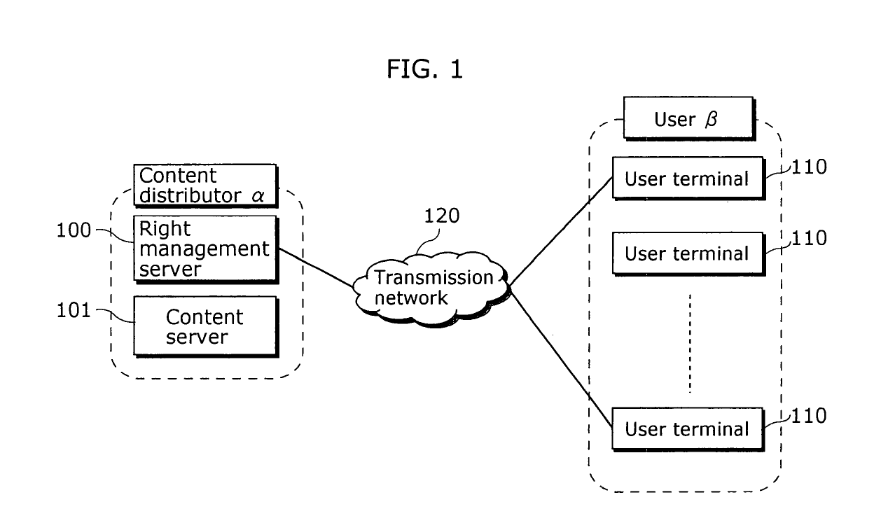

FIG. 1 is a diagram showing an overall configuration of a digital content distribution system in an embodiment of the present invention;

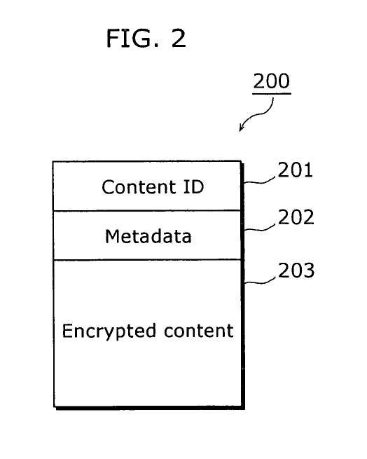

FIG. 2 is a diagram showing a structure of content data in the embodiment of the present invention;

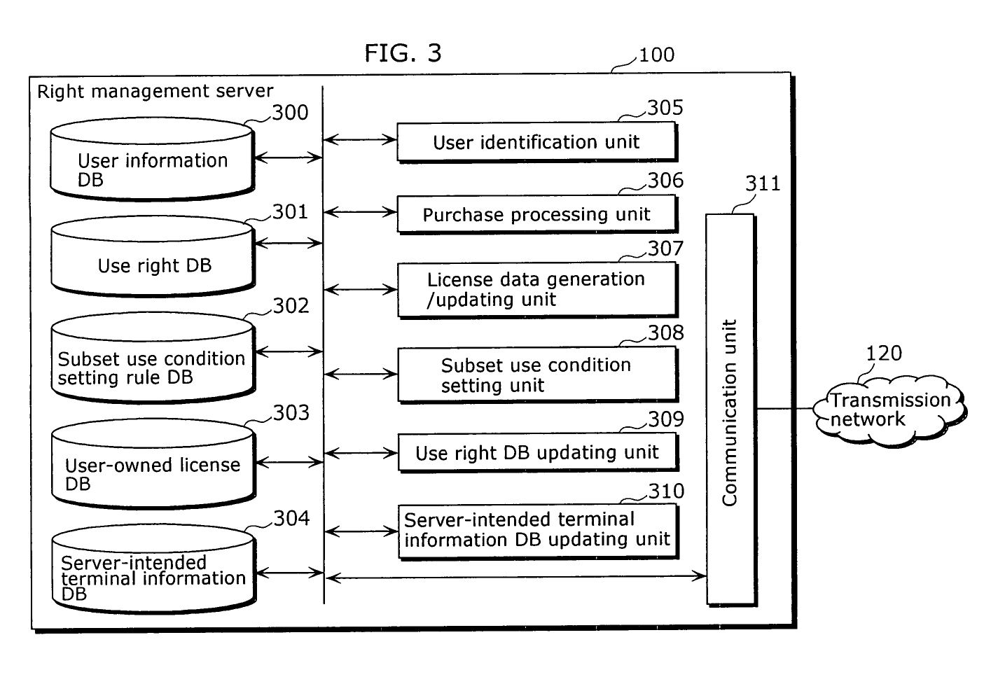

FIG. 3 is a diagram showing a structure of a right management server in the embodiment of the present invention;

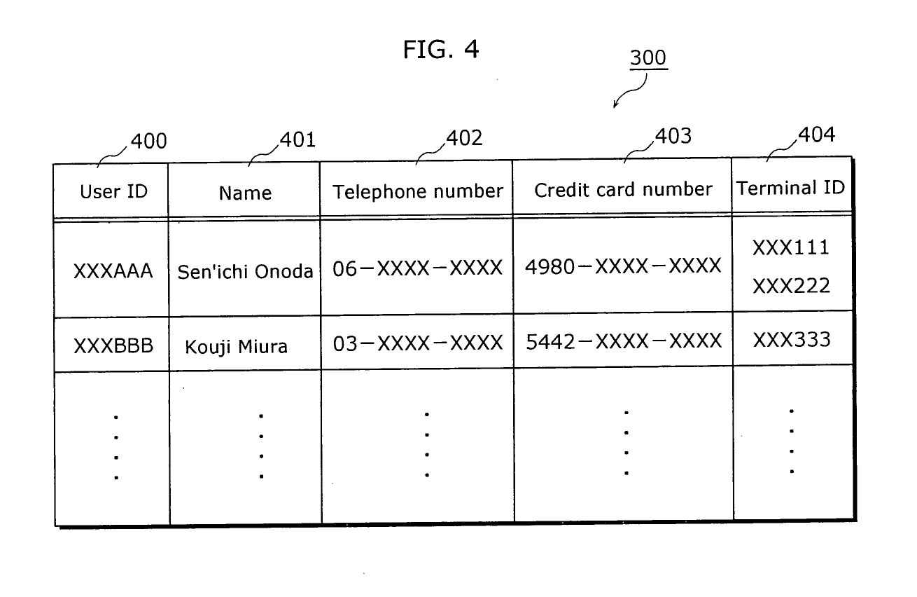

FIG. 4 is a diagram showing an example of a user information database (DB) in the embodiment of the present invention;

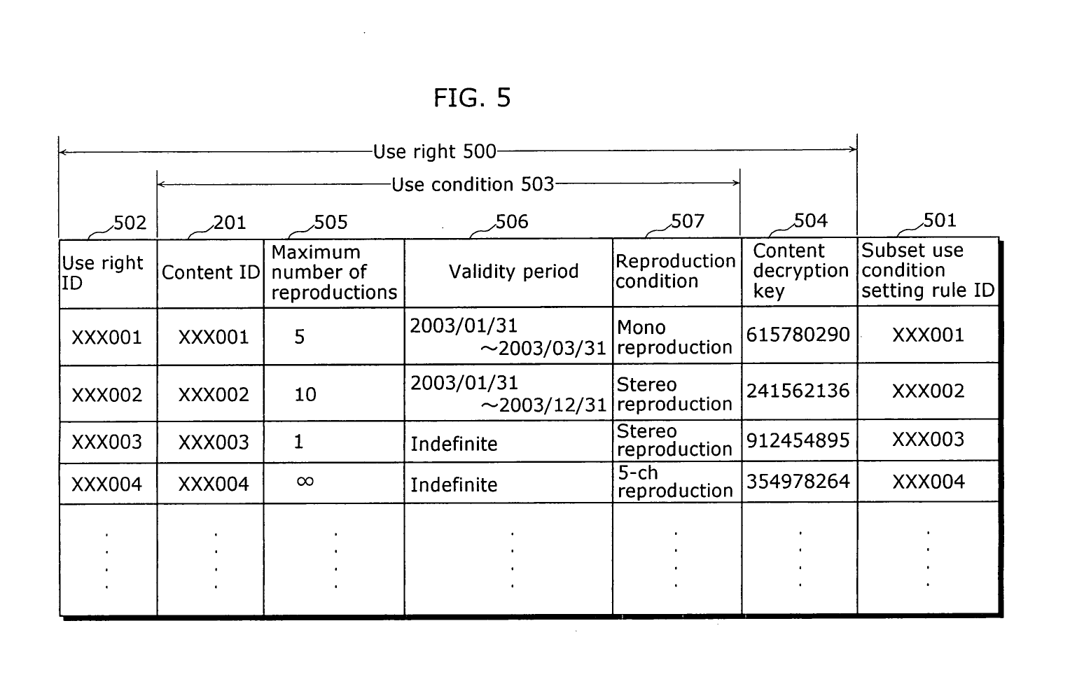

FIG. 5 is a diagram showing an example of a use right DB in the embodiment of the present invention;

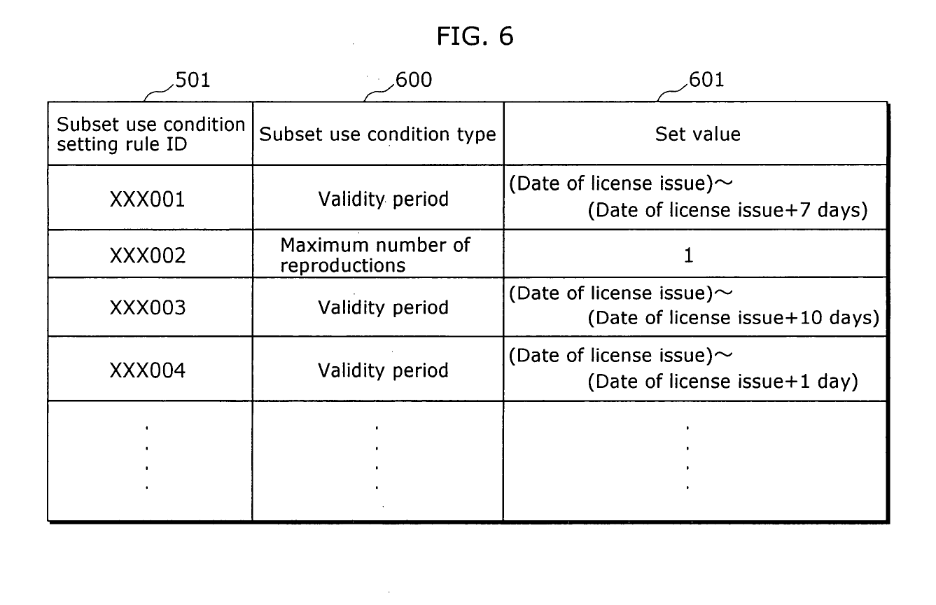

FIG. 6 is a diagram showing an example of a subset use condition setting rule DB in the embodiment of the present invention;

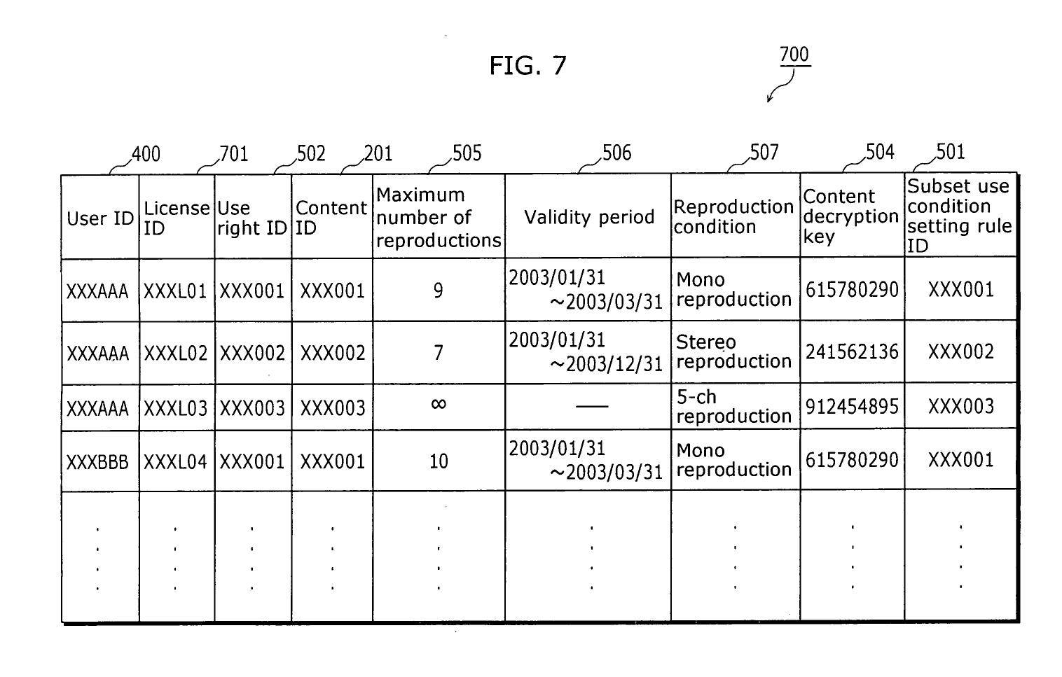

FIG. 7 is a diagram showing an example of a user-owned license DB in the embodiment of the present invention;

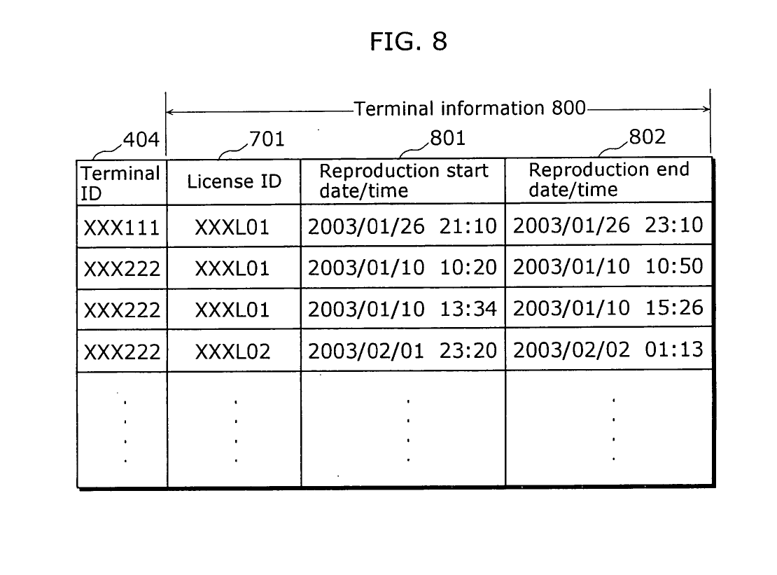

FIG. 8 is a diagram showing an example of a server-intended terminal information DB in the embodiment of the present invention;

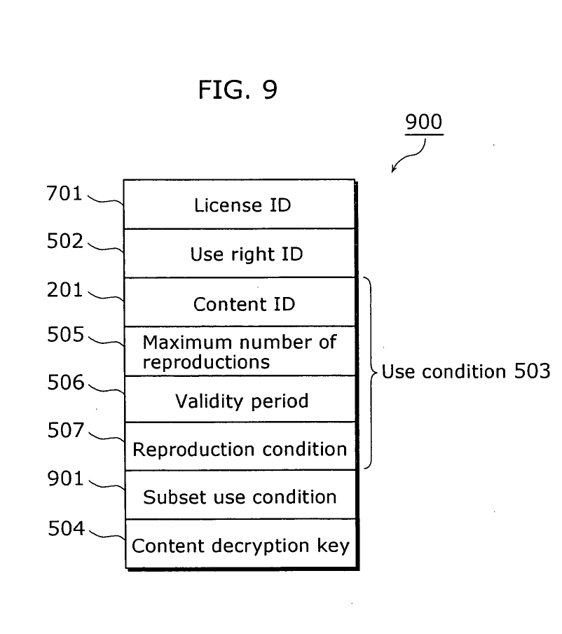

FIG. 9 is a diagram showing a structure of license data in the embodiment of the present invention;

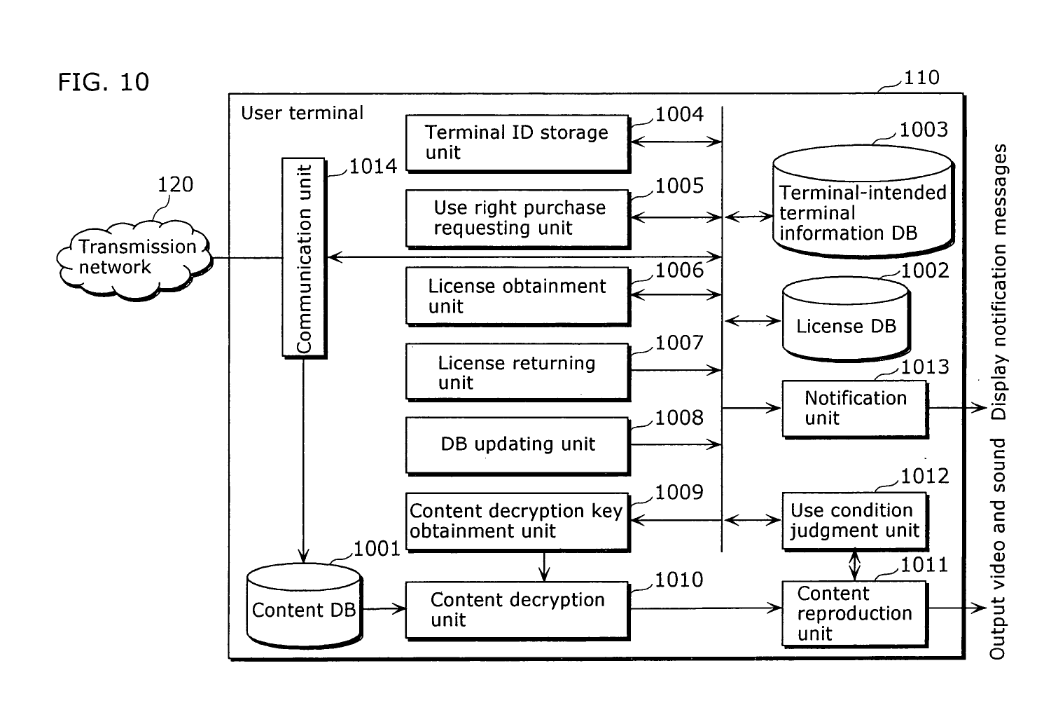

FIG. 10 is a diagram showing a structure of a user terminal in the embodiment of the present invention;

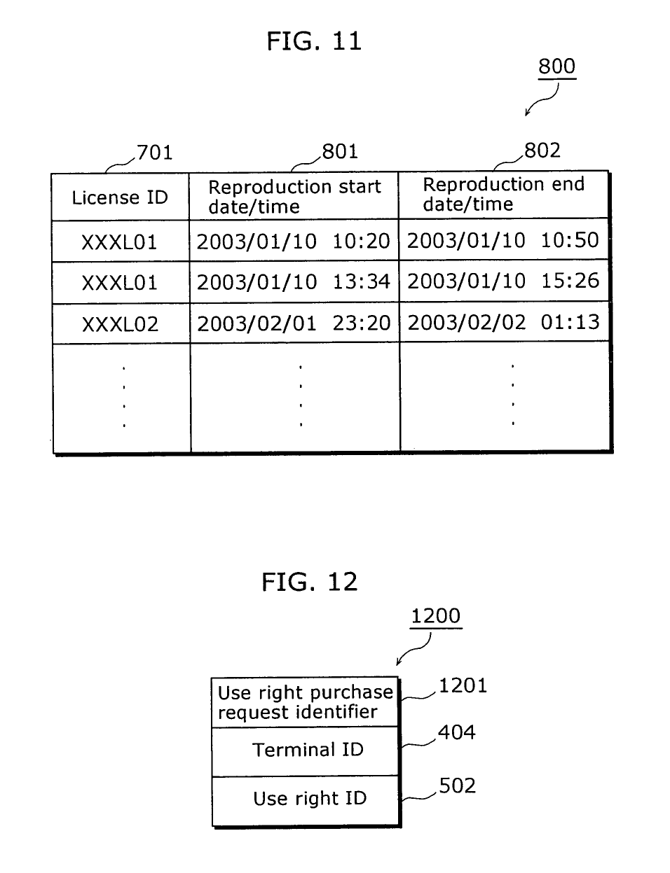

FIG. 11 is a diagram showing a structure of a terminal-intended terminal information DB in the embodiment of the present invention;

FIG. 12 is a diagram showing a structure of a use right purchase request in the embodiment of the present invention;

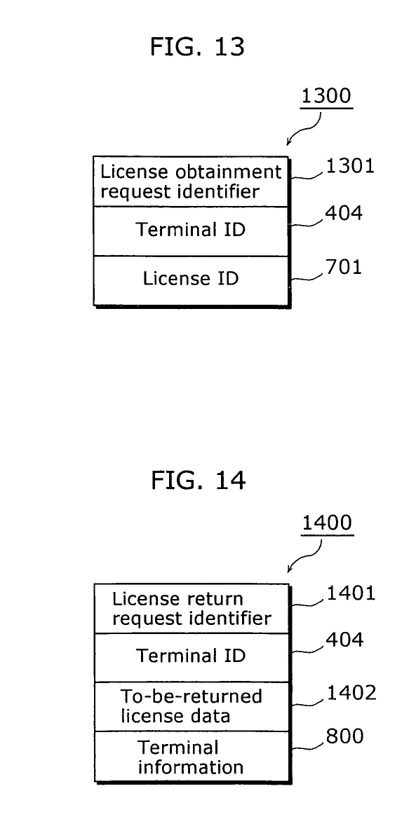

FIG. 13 is a diagram showing a structure of a license obtainment request in the embodiment of the present invention;

FIG. 14 is a diagram showing a structure of a license return request in the embodiment of the present invention;

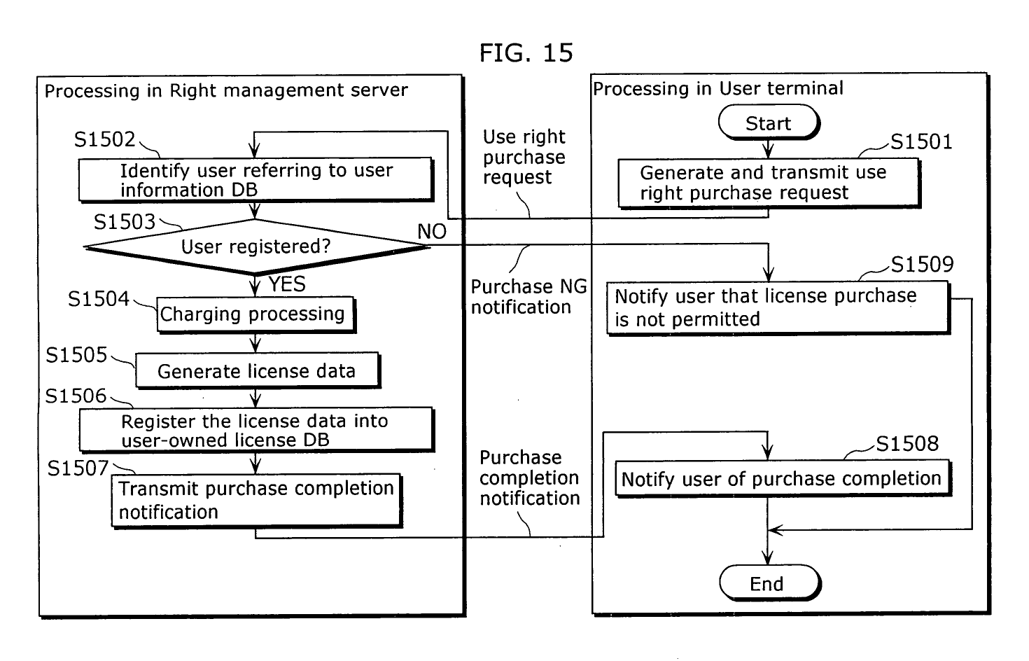

FIG. 15 is a flowchart showing operations executed when a user β purchases a use right in the embodiment of the present invention;

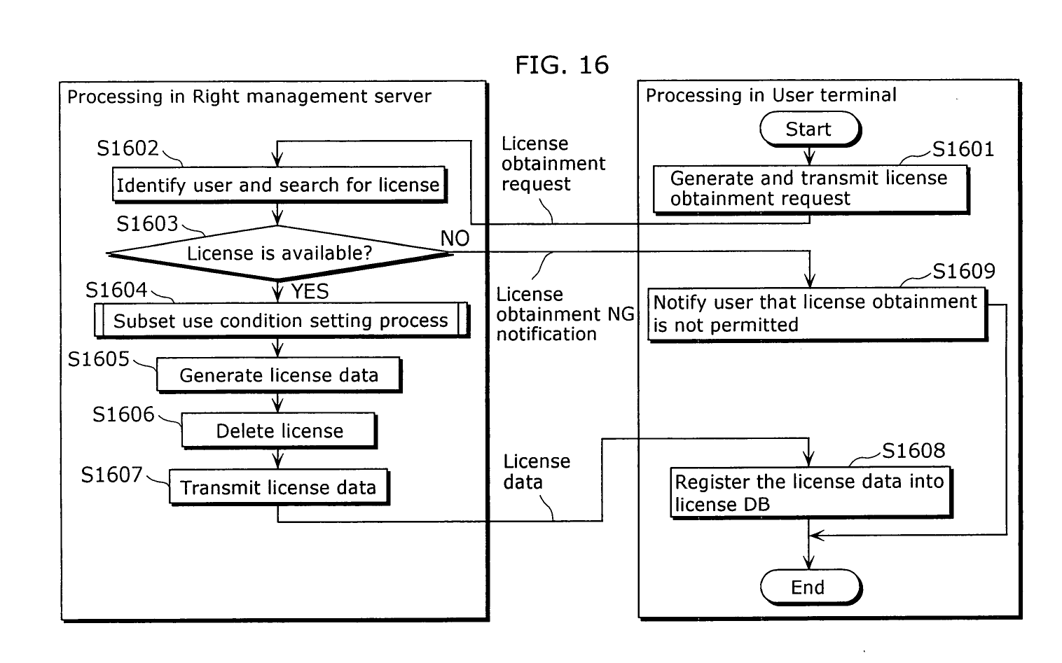

FIG. 16 is a flowchart showing operations executed when the user terminal obtains license data from the right management server in the embodiment of the present invention;

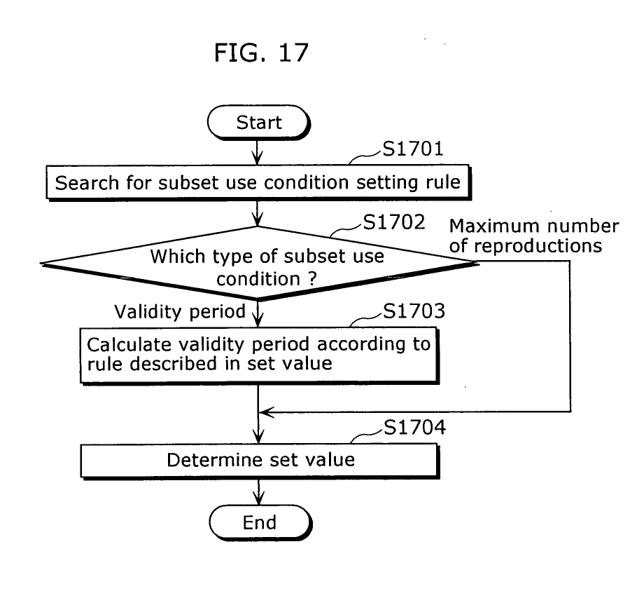

FIG. 17 is a flowchart showing operations in a subset use condition setting process in the embodiment of the present invention;

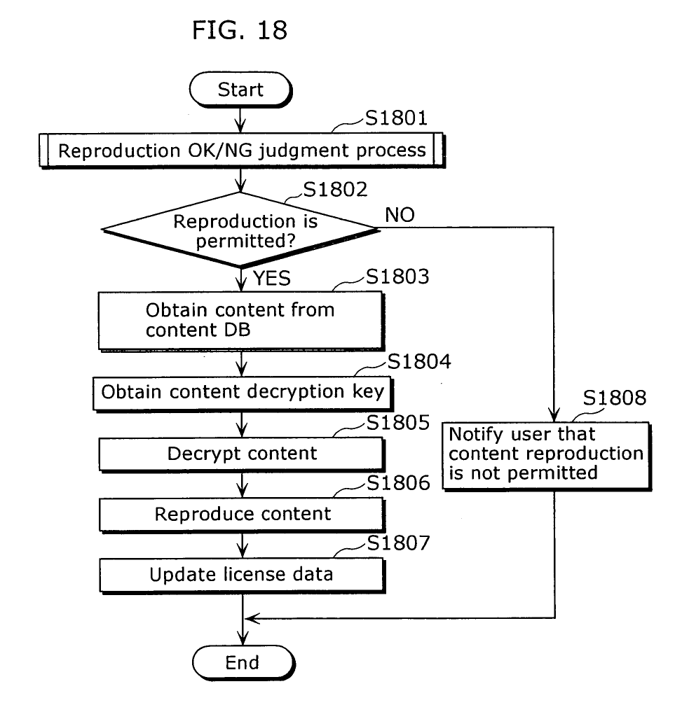

FIG. 18 is a flowchart showing operations executed when the user terminal reproduces the content in the embodiment of the present invention;

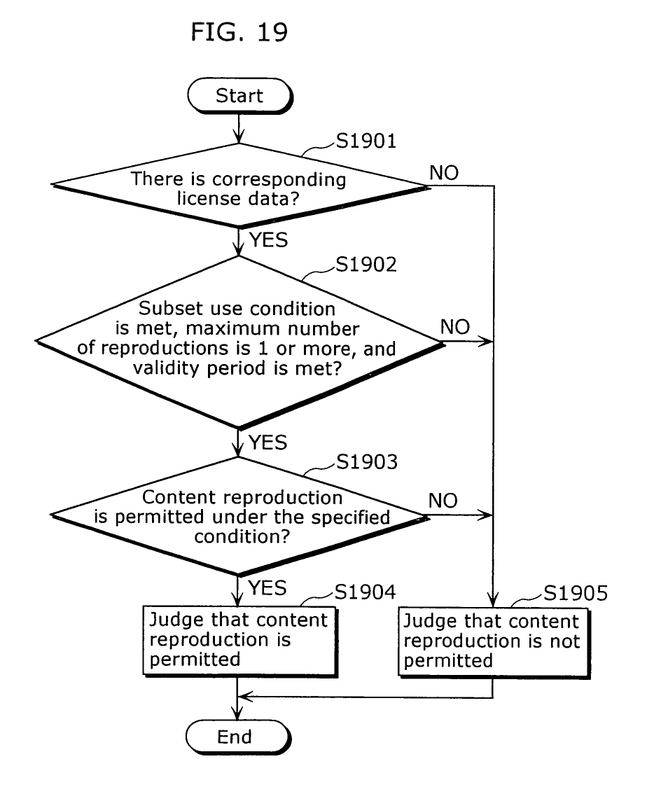

FIG. 19 is a flowchart showing operations in a reproduction OK/NG judgment process in the embodiment of the present invention;

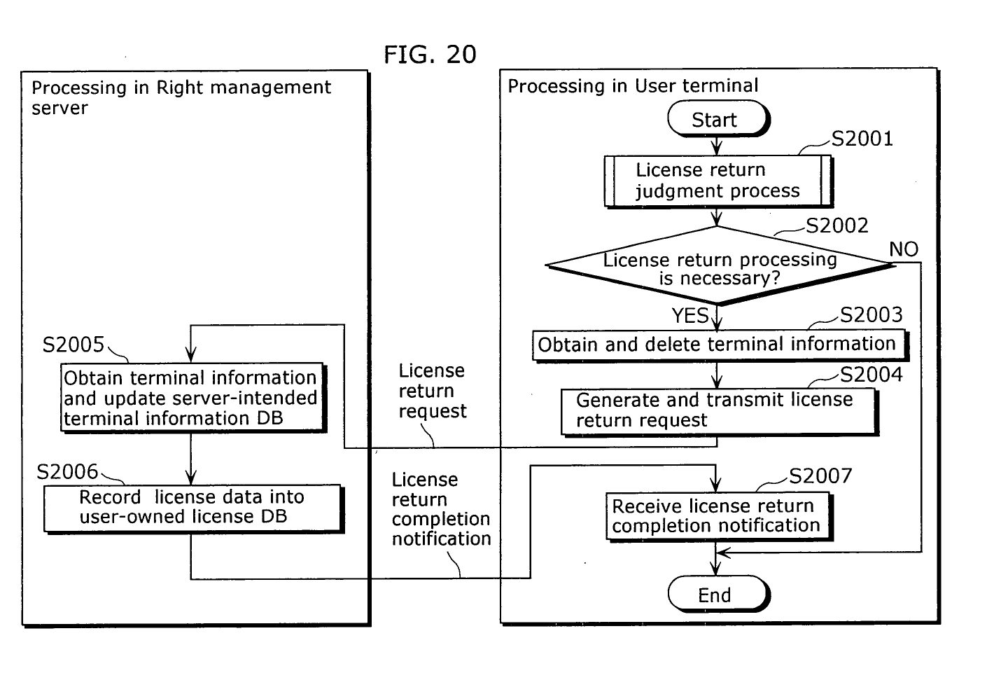

FIG. 20 is a flowchart showing operations executed when the user terminal returns the license data to the right management server in the embodiment of the present invention;

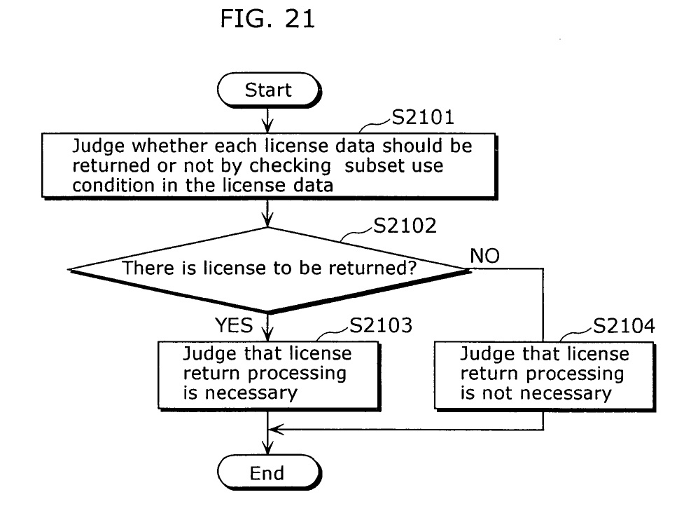

FIG. 21 is a flowchart showing operations in a license return judgment process in the embodiment of the present invention; and

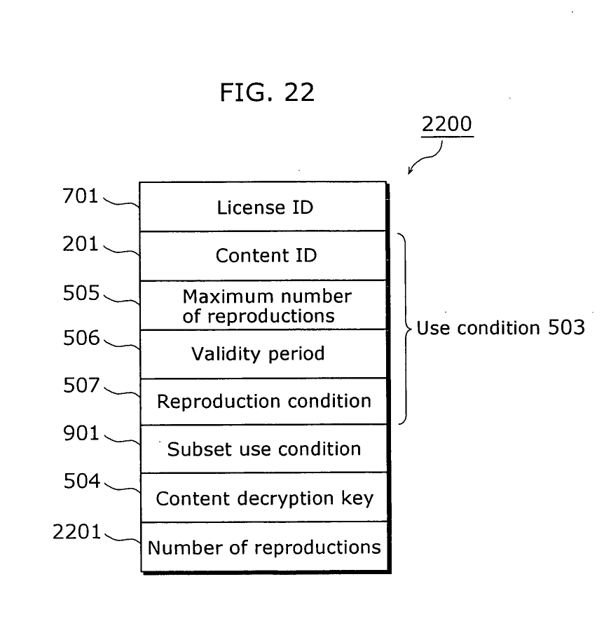

FIG. 22 is a diagram showing a structure of license data in the embodiment of the present invention.

### BEST MODE FOR CARRYING OUT THE INVENTION

The embodiment of the present invention will be explained with reference to the diagrams.

FIG. 1 is a diagram showing an overall configuration of a digital content distribution system in the embodiment of the present invention. In FIG. 1, the digital content distribution system includes at least one right management server 100, at least one content server 101, at least one user terminal 110, and a transmission network 120. Each of these elements in the digital content distribution system will be explained below one by one.

The right management server 100 is a server for managing a use right of each content, and is placed on the side of a content distributor α who is engaged in content distribution. Upon receipt of a request from the user terminal 110, the right management server 100 distributes the use right, as license data 900 as shown in FIG. 9, to the user terminal 110. The license data 900 will be explained later in detail.

The content server 101, like the right management server 100, is placed on the side of the content distributor α, and distributes content data 200 as shown in FIG. 2 to the user terminal 110. As shown in FIG. 2, the content data 200 is comprised of a content ID 201, metadata 202 and an encrypted content 203. The content ID 201 is the ID for identifying uniquely a content in the digital content distribution system. The metadata 202 is data for explaining the descriptions of the content such as the title of the content and the artist's name. The encrypted content 203 is the encrypted content itself such as music data and video data. The contents are not limited to music data and video data, but may be digital contents of any other types such as an electronic newspaper, an electronic book, an electronic map, an electronic dictionary, a still picture, a game, a computer software. In the present embodiment, both the right management server 100 and the content server 101 are placed on the side of the same content distributor α, but a content distributor who runs the right management server 100 may be different from a content distributor who runs the content server 101.

The user terminal 100 is a terminal for receiving content distribution services, and is placed on the side of the user.

The transmission network 120 is a wired or wireless transmission network for connecting the right management server 100 and the content server 101 with the user terminal 110 for communication between them.

The services realized in the present system will be explained. The user β purchases the use right of the content using the user terminal 110, and registers it as a license into the right management server 100. The user terminal 110 obtains the license from the right management server 100 and reproduces the content using the license. The user terminal 110 can return the obtained license to the right management server 100, and obtain the returned license again.

Next, the specific structure of the right management server 100 will be explained with reference to FIG. 3. In FIG. 3, the right management server 100 includes a user information database (DB) 300, a use right DB 301, a subset use condition setting DB 302, a user-owned license DB 303, a server-intended terminal information DB 304, a user identification unit 305, a purchase processing unit 306, a license data generation/updating unit 307, a subset use condition setting unit 308, a use right DB updating unit 309, a server-intended terminal information DB updating unit 310, and a communication unit 311. Each of the elements of the right management server 100 will be explained below one by one.

First, the user information DB 300 will be explained with reference to FIG. 4. The user information DB 300 is a DB for managing information concerning the user β. FIG. 4 is a diagram showing an example of the user information DB 300. In FIG. 4, a user ID 400 is the ID for identifying the user β uniquely in the digital content distribution system. A name 401 is the name of the user β. A telephone number 402 is the telephone number of the user β. A credit card number 403 is the number of the credit card used by the user β for payment of the price for the use right of a content when he/she purchases it. A terminal ID 404 is the ID of the terminal owned by the user β for identifying the user terminal 110 uniquely in the digital content distribution system. As for the user β identified by the user ID “XXXAAA”, for example, FIG. 4 shows that his name is “Sen'ichi Onoda”, his telephone number is “06-XXXX-XXXX”, his credit card number used for the payment is “4980-XXXX-XXXX”, and he owns two terminals identified by the terminal ID “XXX111” and the terminal ID “XXX222”.

The user β registers his data into the user information DB 300 when he/she performs the user registration processing for receiving the content distribution services run by the content distributor α. This user registration processing may be performed by communication with the content distributor α via the transmission network 120, or by any other ways such as transmission of user registration papers. In the user registration processing, the content distributor α first assigns the user ID 400 to the user β. Then, the information required for the registration of the user β such as his name 401, telephone number 402, credit card number 403, terminal ID 404 of his/her user terminal 110 is informed the content distributor α by communication, papers or the like, and this information and the user ID 400 assigned to the user β, which are associated with each other, are registered into the user information DB 300. As a result of the above user registration processing, the user information DB 300 as shown in FIG. 4 is constructed.

Next, the use right DB 301 that is a DB for managing use rights of contents will be explained with reference to FIG. 5. FIG. 5 is a diagram showing an example of the use right DB 301. In FIG. 5, the use right DB 301 is comprised of a use right 500 of each content and a subset use condition setting rule ID 501 for identifying a rule which is referred to when the right management server 100 sets a subset use condition 901 in license data 900. The subset use condition is a condition which should be met in order to use a license. It will be explained later in detail. The use right 500 is comprised of a use right ID 502, a use condition 503 and a content decryption key 504, and further the use condition 503 is comprised of the content ID 201, a maximum number of reproductions 505, a validity period 506 and a reproduction condition 507. Each element of the use right 500 will be explained below one by one.

The use right ID 502 is the ID for identifying the use right 500 uniquely in the digital content distribution system. In the content ID 201, the ID of a content which is subject to the use right 500 is described. The maximum number of reproductions 505 is the number of times within which the content is permitted to be reproduced. The validity period 506 shows the period during which the content is permitted to be used, and the start and expiry dates of the validity period are described therein. The reproduction condition 507 is the information specifying the condition for reproducing the content. For example, if “mono reproduction” is specified, the content should be reproduced in monophonic sound on the user terminal 110. The content decryption key 504 is the decryption key for decrypting the content identified by the content ID 201. In the following explanation, a usage amount of a right shall be represented by the maximum number of reproductions, but instead, it may be represented by the maximum total time period of reproductions.

As for the use right 500 identified by the use right ID “XXX001”, for example, FIG. 5 shows that the content ID of a content which is subject to the right is “XXX001”, the decryption key for decrypting the content is “615780290”, the maximum number of reproductions for the content is “5 times”, the validity period thereof is “2003/01/31˜2003/03/31”, and the reproduction condition is “mono reproduction”. In addition, FIG. 5 shows that the subset use condition 901, which is set when the right management server 100 distributes the license to the user terminal 110, shall be set according to the subset use condition setting rule identified by the subset use condition setting rule ID “XXX001”.

The explanation of each element of the right management server 100 will be continued with reference back to FIG. 3. The subset use condition setting rule DB 302 is a DB for managing a setting rule for a subset use condition which should be set for a license when the right management server 100 passes the license to the user terminal 110. The subset use condition setting rule DB 302 will be explained with reference to FIG. 6. The subset use condition setting rule ID 501 is the identifier for identifying a subset use condition setting rule uniquely. The subset use condition type 600 is a type of the condition which should be set as a subset use condition. There are two subset use condition types, the “validity period” and the “maximum number of reproductions”. The set value 601 indicates a value which should be set as a use condition. FIG. 6 shows that in the case where the subset use condition setting rule ID “XXX001” is chosen, for example, the value of “(date of license issue)˜(date of license issue+7 days)” is to be set as a validity period.

There are only two subset use condition types 600, the “validity period” and the “maximum number of reproductions”, in the present embodiment, but any other subset use condition types 600 may be set as far as they restrict content use on the user terminal 110. For example, the subset use condition type 600 may be the “maximum total time period of reproductions”. In the case where the “maximum number of reproductions 505” is described in the use condition 503 in the license data 900, it may be set so that the subset use condition type 600 in this license data 900 is always the “maximum number of reproductions”. In addition, the subset use condition can be set for each use right in the present embodiment, as shown in FIG. 5, but the subset use condition does not always need to be set for each use right. For example, in the case where a license for every use right should be returned every time a content is reproduced once, the subset use condition “the maximum number of reproductions is 1” can be set for every license. Or, in the case where a license for every use right should be returned every one week from the date of license issue, the subset use condition “the date of license issue+7 days” can be set for every license. Furthermore, in the case where the use rights are divided into groups according to some commonality (such as a content genre), the subset use condition common to each group may be set.

The explanation of each element of the right management server 100 will be continued with reference back to FIG. 3. The user-owned license DB 303 is a DB for managing a license held by the right management server 100, not held by the user terminal 110, out of the licenses owned by the user β. The user-owned license DB 303 will be explained with reference to FIG. 7. The user ID 400 is the identifier for identifying the user β. The license ID 701 is the identifier for the license which is assigned by the right management server 100 when the user β purchases the use right. The use right ID 502 is the identifier for identifying the use right which is the source of the license. The content ID 201 is the identifier for identifying a content which is permitted to be used under the license. The maximum number of reproductions 505 is the number of times within which the content is permitted to be reproduced under the license. The validity period 506 is a period during which the content is valid. The reproduction condition 507 specifies the condition for reproducing the content. The content decryption key 504 is the decryption key for decrypting the encrypted content. The subset use condition setting rule ID 501 is the identifier for identifying the subset use condition setting rule uniquely. In FIG. 7, for example, the user identified by the user ID “XXXAAA” owns three licenses identified by the license IDs “XXXL01”, “XXXL02” and “XXXL03”. In addition, FIG. 7 shows that under the license identified by the license ID “XXXL01” owned by the user identified by the user ID “XXXAAA”, the content identified by the content ID “XXX001” is permitted to be reproduced 9 times in “mono reproduction” during the period of “2003/01/31˜2003/03/31”. It also shows that the content identified by the content ID “XXX001” can be decrypted by the decryption key “615780290” and the subset use condition 901 which is represented by the value of the validity period “(date of license issue)˜(date of license issue+7 days)” is set according to the subset use condition rule identified by the subset use condition setting rule ID “XXX001” when the license of the content is issued.

The explanation of each element of the right management server 100 will be continued with reference back to FIG. 3. The server-intended terminal information DB 304 is a DB for managing information concerning a terminal (the information is referred to as “terminal information” in the following description, and as “history information” in the claims), such as content history logs, which is transmitted together with the license from the user terminal 110 when the license is returned from the user terminal 110. FIG. 8 is a diagram showing an example of the server-intended terminal information DB 304. FIG. 8 is comprised of the terminal ID 404 and the terminal information 800. Further, the terminal information 800 is comprised of the license ID 701, the reproduction start date/time 801 when reproduction of a content starts, and the reproduction end date/time 802 when the reproduction of the content ends. FIG. 8 shows, for example, that the terminal identified by the terminal ID “XXX111” was reproducing the content during the period from “2003/01/26 21:10” to “2003/01/26 23:10” using the license identified by the license ID “XXXL01.

The explanation of each element of the right management server 100 will be continued with reference back to FIG. 3. The user identification unit 305 identifies the user β by referring to the user information DB 300 based on the terminal ID 404 transmitted from the user terminal 110.

The purchase processing unit 306 performs the necessary charging processing and the like in response to the use right purchase request from the user terminal 110.

The license data generation/updating unit 307 generates the license data 900 as shown in FIG. 9 based on the use right managed in the use right DB 301, and registers it into the user-owned license DB 303. As shown in FIG. 9, the license data 900 indicating the data structure of the license is comprised of the license ID 701, the use right ID 502, the use condition 503, the subset use condition 901 and the content decryption key 504. When the license data generation/updating unit 307 generates the license data 900, it shall set the use right ID 502, the use condition 503 and the content decryption key 504 of the use right 500, which is the source for issuing the license data 900, respectively in the use right ID 502, the use condition 503 and the content decryption key 504 of the license data 900. As for the license ID 701, the value which is unique in the right management server 100 is set. The set value for the subset use condition 901 will be described later.

The subset use condition setting unit 308 is a processing unit for setting an appropriate condition as the subset use condition 901 of the license data 900. Here, the subset use condition 901 is a condition for restricting the use of the license issued from the right management server 100 to the user terminal 110, and a value of a subset of a use condition is set for the license. How to set the value will be specifically described later.

Again back to FIG. 3, the use right DB updating unit 309 updates the data in the use right DB 301. To be more specific, the use right DB updating unit 309 additionally registers new use right data which is sold by the content distributor α into the use right DB 301.

The server-intended terminal information DB updating unit 310 updates the data in the server-intended terminal information DB 304. To be more specific, upon receipt of the license return request 1400 to be described later via the communication unit 311, it obtains the terminal ID 404 and the terminal information 800 included in the request 1400 and records them into the server-intended terminal information DB 304.

The communication unit 311 communicates with the user terminal 110 via the transmission network 120.

This is the end of the explanation of the right management server 100.

Next, the structure of the user terminal 110 will be specifically explained with reference to FIG. 10. In FIG. 10, the user terminal 110 includes a content DB 1001, a license DB 1002, a terminal-intended terminal information DB 1003, a terminal ID storage unit 1004, a use right purchase requesting unit 1005, a license obtainment unit 1006, a license returning unit 1007, a DB updating unit 1008, a content decryption key obtainment unit 1009, a content decryption unit 1010, a content reproduction unit 1011, a use condition judgment unit 1012, a notification unit 1013, and a communication unit 1014. Each element of the user terminal 110 will be explained below one by one.

The content DB 1001 is a DB for managing the content data 200 distributed from the content server 101.

The license DB 1002 is a DB for managing the license data 900 distributed from the right management server 100.

The terminal-intended terminal information DB 1003 is a DB for managing the terminal information 800 such as history logs of contents used on the user terminal 110. The terminal-intended terminal information DB 1003 will be explained with reference to FIG. 11. FIG. 11 is a diagram showing an example of data in the terminal-intended terminal information DB 1003. In FIG. 11, the terminal-intended terminal information DB 1003 is comprised of the license ID 701, the reproduction start date/time 801 and the reproduction end date/time 802. FIG. 11 shows, for example, that this user terminal 110 was reproducing the content during the periods from “2003/01/10 10:20” to “2003/01/10 10:50” and from “2003/01/10 13:34” to “2003/01/10 15:26” using the license identified by the license ID “XXXL01”.

The communication unit 1014 communicates with the right management server 100 and the content server 101 via the transmission network 120.

The use right purchase requesting unit 1005 is a processing unit for purchasing the use right of a content by generating a use right purchase request as shown in FIG. 12 and transmitting it to the right management server 100. In FIG. 12, the use right purchase request 1200 is comprised of a use right purchase request identifier 1201, the terminal ID 404 and the use right ID 502. In the use right purchase request identifier 1201, information indicating that this data is the use right purchase request 1200 is described. In the terminal ID 404, the terminal ID 404 of the user terminal 110 which transmits the use right purchase request 1200 is described. In the use right ID 502, the ID of the use right 500 of which purchase is to be requested is described.

The license obtainment unit 1006 is a processing unit for obtaining the license data 900 by generating the license obtainment request 1300 as shown in FIG. 13 and transmitting it to the right management server 100. In FIG. 13, the license obtainment request 1300 is comprised of the license obtainment request identifier 1301, the terminal ID 404 and the license ID 701. In the license obtainment request identifier 1301, information indicating that this data is the license obtainment request 1300 is described. In the terminal ID 404, the terminal ID 404 of the user terminal 110 which transmits the license obtainment request is described. In the license ID 701, the ID of the license data 900 of which obtainment is to be requested is described.

The license returning unit 1007 is a processing unit for returning invalid license data, out of the license data 900 stored in the license DB 1002, to the right management server 100. To be more specific, the license returning unit 1007 first judges whether each of the license data 900 stored in the license DB 1002 is valid or not with reference to the use condition 503 and the subset use condition 901. If there is the invalid license data 900, the license returning unit 1007 generates a license return request 1400 as shown in FIG. 14 and returns the license to the right management server 100. In FIG. 14, the license return request 1400 is comprised of a license return request identifier 1401, the terminal ID 404, a to-be-returned license data 1402 and the terminal information 800. In the license return request identifier 1401, information indicating that this data is the license return request 1400 is described. In the terminal ID 404, the terminal ID 404 of the user terminal 110 which transmits the license return request 1400 is described. In the to-be-returned license data 1402, the license data 900 which is judged invalid and to be returned is described. The terminal information 800 whose license ID matches with the license ID 701 of the license to be returned is obtained from the terminal-intended terminal information DB 1003 and described in the terminal information 800.

The DB updating unit 1008 updates the license DB 1002 and the terminal-intended terminal information DB 1003. To be more specific, in the embodiment of the present invention, the DB updating unit 1008 subtracts 1 from the maximum number of reproductions 505 in the license data 900 stored in the license DB 1002 when the content is reproduced, and at the same time, adds the new terminal information 800 into the terminal-intended terminal information DB 1003.

The content decryption key obtainment unit 1009 is a processing unit for extracting the content decryption key 504 which is a key for decrypting the content from the license data 900 stored in the license DB 1002.

The content decryption unit 1010 is a processing unit for extracting the content data 200 from the content DB 1001 and decrypting the encrypted content 203 in the extracted content data 200 using the content decryption key 504 obtained by the content decryption key obtainment unit 1009.

The content reproduction unit 1011 is a processing unit for reproducing the content decrypted by the content decryption unit 1010 according to the condition specified by the reproduction condition 507 in the license data 900, and music and video are outputted through a speaker and a display not shown in the diagram.

The use condition judgment unit 1012 judges whether reproduction of the content is permitted or not with reference to the maximum number of reproductions 505 and the subset use condition 901 in the license data 900.

The notification unit 1013 is a processing unit for notifying the user β of various messages.

The terminal ID storage unit 1004 is a processing unit for storing the terminal ID 404 which is the ID for identifying the user terminal 110 uniquely in the digital content distribution system.

This is the end of the explanation of the user terminal 110.

Next, the operations performed in the digital content distribution system of the present embodiment will be explained using a flowchart.

First, the operations performed when the user β purchases the use right of the content and the user terminal 110 registers the user-owned license data into the user-owned license DB 303 in the right management server 100 will be explained with reference to the flowchart as shown in FIG. 15.

S1501: The use right purchase requesting unit 1005 receives a use right purchase instruction from the user β via a user operation entry unit not shown in the diagram, such as a keyboard. It is assumed that his/her use right purchase instruction includes the use right ID 502 of the use right that the user β wants to purchase. In response to the use right purchase instruction from the user β, the use right purchase requesting unit 1005 generates the use right purchase request 1200 and transmits it to the right management server 100 via the communication unit 1014. It is assumed here that the terminal ID 404 held in the terminal ID storage unit 1004 is set in the terminal ID 404 in the use right purchase request 1200, and the use right ID 502 included in the use right purchase instruction from the user β is set in the use right ID 502 in the use right purchase request 1200.

S1502: Upon receipt of the use right purchase request 1200 via the communication unit 311, the user identification unit 305 identifies the user β who wants to purchase the use right by referring to the user information DB 300 based on the terminal ID 404 included in the use right purchase request 1200.

S1503: In the case where the user β cannot be identified in S1502, namely, where the user has not been registered, the user identification unit 305 notifies the user terminal 110 via the communication unit 311 that the use right is not permitted to be purchased. In the case where the user β can be identified, it goes to the processing of S1504.

S1504: The purchase processing unit 306 performs charging processing using the information of the user β identified by the user identification unit 305.

S1505: The license data generation/updating unit 307 generates the user-owned license data 700. It is assumed here that the user ID 400 of the user β who wants to purchase the use right, the number which is unique in the right management server 100 and the use right ID 502 included in the use right purchase request 1200 are respectively set in the user ID 400, the license ID 701 and the use right ID 502 in the generated user-owned license data 700. In addition, the values which are set in the use right data identified by the use right ID 502 included in the use right purchase request 1200 are set respectively in the content ID 201, the maximum number of reproductions 505, the validity period 506, the reproduction condition 507, the content decryption key 504 and the subset use condition setting rule ID 501 in the user-owned license data 700.

S1506: The license data generation/updating unit 307 registers the user-owned license data 700 generated in S1507 into the user-owned license DB 303.

S1507: The communication unit 311 transmits a purchase completion notification to the user terminal 110.

S1508: The use right purchase requesting unit 1005 receives, via the communication unit 1014, the purchase completion notification transmitted in S1507, notifies the user β via the notification unit 1013 that the purchase of the use right has been completed, and ends the processing.

S1509: In the case where it is judged in S1503 that the user has not been registered, the use right purchase requesting unit 1005 receives a purchase NG notification from the right management server 100 via the communication unit 1014. In this case, the use right purchase requesting unit 1005 notifies the user R via the notification unit 1013 that the purchase of the use right has not been permitted, and ends the processing.

This is the end of the explanation of the operations performed when the user β purchases the use right of the content.

In the present embodiment, in the case where it is judged in S1503 that the user has not been registered, the user β is notified that the purchase of the use right has not been permitted in S1509 and the processing is ended. However, it is also possible to register the user immediately after S1503 to continue the processing of S1504 and the following.

Next, the operations performed when the user β obtains the license required for reproduction of the content from the right management server 100 will be explained with reference to the flowchart of FIG. 16.

S1601: The license obtainment unit 1006 receives a license obtainment instruction from the user β via the user operation entry unit not shown in the diagram, such as a keyboard. This license obtainment instruction includes the license ID 701 of the license required for reproduction of the content that the user β wants to obtain. The license obtainment unit 1006 generates the license obtainment request 1300 in response to the license obtainment instruction from the user β, and transmits it to the right management server 100 via the communication unit 1014. It is assumed here that the terminal ID 404 held in the terminal ID storage unit 1004 is set in the terminal ID 404 in the license obtainment request 1300 and the license ID 701 included in the license obtainment instruction from the user β is set in the license ID 701 in the request 1300.

S1602: Upon receipt of the license obtainment request 1300 via the communication unit 311, the user identification unit 305 identifies the user ID 400 of the user β who wants to obtain the license by referring to the user information DB 300 based on the terminal ID 404 included in the license obtainment request 1300, and transmits the license ID 701 and the user ID 400 included in the license obtainment request 1300 to the license data generation/updating unit 307. The license data generation/updating unit 307 searches for the license to be obtained, by referring to the user-owned license DB 303 based on the license ID 701 and the user ID 400.

S1603: In the case where the license data generation/updating unit 307 cannot search out the license in S1602, it notifies the user terminal 110 via the communication unit 311 that the obtainment of the license is not permitted. In the case where the license data generation/updating unit 307 searches out the license in S1602, it goes to the processing of S1604.

S1604: The license data generation/updating unit 307 sets the value of the subset use condition 901 via the subset use condition setting unit 308. The process of setting the subset use condition 901 will be explained later in detail.

S1605: The license data generation/updating unit 307 generates the license data 900. In the subset use condition 901 in the generated license data 900, the subset use condition 901 determined in S1604 is described. As for the other data, the corresponding values in the user-owned license data 700 searched out in S1602 are set.

S1606: The license data generation/updating unit 307 deletes the user-owned license data 700 searched out in S1602 from the user-owned license DB 303.

S1607: The license data generation/updating unit 307 transmits the license data 900 generated in S1605 to the user terminal 110 via the communication unit 311.

S1608: The license obtainment unit 1006 receives, via the communication unit 1014, the license data 900 transmitted in S1607, and registers the received license data 900 into the license DB 1002.

S1609: In the case where the user terminal 110 receives the license obtainment NG notification, the license obtainment unit 1006 notifies the user β via the notification unit 1013 that the obtainment of the license is not permitted, and ends the processing.

This is the end of the explanation of the operations performed when the user β obtains the license required for reproduction of the content from the right management server 100.

Next, the subset use condition setting process in S1604 of FIG. 16 will be explained with reference to the flowchart of FIG. 17. The subset use condition setting process is a process for setting the value of the subset use condition 901 to be set in the license data 900 to be issued to the user terminal 110.

S1701: The subset use condition setting unit 308 searches the subset use condition setting rule DB 302 to find the data that corresponds to the subset use condition setting rule ID 501 in the user-owned license data 700.

S1702: In the case where the subset use condition type 600 of that data is the maximum number of reproductions, the subset use condition setting unit 308 goes to the processing of S1704. In the case where the subset use condition type 600 is the validity period, it goes to the processing of S1703.

S1703: The subset use condition setting unit 308 calculates the validity period according to the rule described in the set value of the data. For example, when the set value is “(date of license issue)˜(date of license issue+7 days)” and the date of license issue is Jan. 7, 2003, the validity period “2003/01/07˜2003/01/14” is calculated as the subset use condition 901.

S1704: In the case where the subset use condition type 600 is the validity period, the subset use condition setting unit 308 compares the value calculated in S1703 with the validity period 506 described in the license data 900, and sets the subset use condition 901 so as to minimize the validity period. In other words, as the set value, the latest date is chosen for the start date of the validity period and the earliest date is chosen for the expiry date thereof. On the other hands, in the case where the subset use condition type 600 is the maximum number of reproductions, the subset use condition setting unit 308 compares the maximum number of reproductions described in the subset use condition setting rule with the maximum number of reproductions 505 in the license data 900, and sets the smaller value as the set value. As a result, both the set value and the subset use condition type 600 are set in the subset use condition 901.

This is the end of the explanation of the subset use condition setting process executed in S1604 of FIG. 16.

Next, the operations performed when the user terminal 110 reproduces the content in the digital content distribution system in the present embodiment will be explained with reference to the flowchart in FIG. 18.

S1801: The use condition judgment unit 1012 receives, via the user operation entry unit not shown in the diagram, such as a keyboard, the content reproduction instruction from the user β. It is assumed that the content reproduction instruction from the user β includes information identifying the content that the user β wants to reproduce. The use condition judgment unit 1012 executes the reproduction OK/NG judgment process to be described later with reference to the flowchart in FIG. 19 so as to judge whether the reproduction of the content is permitted or not.

S1802: In the case where the use condition judgment unit 1012 judges in S1801 that the reproduction of the content is permitted, it goes to the processing of S1803. In the case where it judges that the reproduction of the content is not permitted, it goes to the processing of S1808.

S1803: The content decryption unit 1010 extracts the content data 200 that the user β wants to reproduce from the content DB 1001.

S1804: The content decryption key obtainment unit 1009 extracts the content decryption key 504 from the license data 900 corresponding to the content that the user β wants to reproduce.

S1805: The content decryption unit 1010 decrypts the encrypted content 203 included in the content data 200 extracted in S1803 using the content decryption key 504 obtained by the content decryption key obtainment unit 1009 in S1804.

S1806: The content reproduction unit 1011 reproduces the encrypted content 203 decrypted by the content decryption unit 1010 in S1805, under the condition specified by the reproduction condition 507 in the license data 900.

S1807: The DB updating unit 1008 subtracts 1 from the maximum number of reproductions 505 used for the reproduction in the license data 900. When the maximum number of reproductions is set in the subset use condition 901, the DB updating unit 1008 also subtracts 1 from that number. Also, the DB updating unit 1008 stores and holds the date/time of the content reproduction start, and when the reproduction ends, it records both dates/times of the content reproduction start and end, as the terminal information 800, into the terminal-intended terminal information DB 1003 via the DB updating unit 1008.

S1808: The use condition judgment unit 1012 notifies the user β via the notification unit 1013 that the reproduction of the content is not permitted.

This is the end of the explanation of the operations performed when the user terminal 110 reproduces the content.

Next, the reproduction OK/NG judgment process in S1801 of FIG. 18 will be explained with reference to the flowchart in FIG. 19. The reproduction OK/NG judgment process is a process for judging whether the reproduction of the content that the user β wants to reproduce is permitted or not.

S1901: The use condition judgment unit 1012 checks whether or not the license data 900 corresponding to the content that the user β wants to reproduce exists in the license DB 1002. In the case where there exists the corresponding license data 900, the use condition judgment unit 1012 goes to the processing of S1902. In the case where there exists no corresponding license data 900, the use condition judgment unit 1012 goes to the processing of S1905.

S1902: The use condition judgment unit 1012 judges whether or not (1) the subset use condition 901 in the license data 900 corresponding to the content that the user β wants to reproduce is met; (2) the maximum number of reproductions is 1 or more; and (3) the reproduction date/time meets the validity period 506. How to judge the subset use condition 901 will be explained here. In the case where the validity period is set in the subset use condition 901, it is judged whether or not the reproduction of the content starts within the validity period. In the case where the maximum number of reproductions is set in the subset use condition 901, it is judged whether or not that number is 1 or more. In the case where the subset use condition 901 is met, the maximum number of reproductions 505 is 1 or more, and the reproduction start date/time meets the validity period 506, the use condition judgment unit 1012 goes to the processing of S1903. In the case where the subset use condition 901 is not met, the maximum number of reproductions 505 is not 1 or more, or the reproduction start date/time does not meet the validity period 506, the use condition judgment unit 1012 goes to the processing of S1905.

S1903: The use condition judgment unit 1012 judges whether or not the content reproduction unit 1011 is permitted to reproduce the content under the condition specified by the reproduction condition 507, with reference to the reproduction condition 507 in the license data 900 corresponding to the content that the user β wants to reproduce. When the reproduction is permitted under the specified condition, the use condition judgment unit 1012 goes to the processing of S1904. When the reproduction is not permitted under the specified condition, the use condition judgment unit 1012 goes to the processing of S1905.

S1904: The use condition judgment unit 1012 judges that the reproduction of the content is permitted.

S1905: The use condition judgment unit 1012 judges that the reproduction of the content is not permitted.

This is the end of the explanation of the reproduction OK/NG judgment process.

Next, the operations performed when the user terminal 110 returns the license data 900 held in the license DB 1002 in the digital content distribution system in the present embodiment will be explained with reference to the flowchart in FIG. 20.

S2001: The license returning unit 1007 starts the license return processing at an appropriate timing such as the timing when power is applied to the user terminal 110. The license returning unit 1007 executes the license return judgment process to be described later with reference to the flowchart in FIG. 21 so as to judge whether the license return processing is necessary or not.

S2002: When the license returning unit 1007 judges that the license return processing is necessary, it goes to the processing of S2003. When it judges that the license return processing is not necessary, it ends the processing.

S2003: The license returning unit 1007 obtains, from the terminal-intended terminal information DB 1003, all the terminal information 800 including the license ID which matches with the license ID 701 in the license data 900 to be returned from the terminal-intended terminal information DB 1003, and deletes them from the terminal-intended terminal information DB 1003 via the DB updating unit 1008.

S2004: The license returning unit 1007 generates the license return request 1400 as shown in FIG. 14, and transmits it to the right management server 100 via the communication unit 1014. Here, the license returning unit 1007 describes the license data 900 of which return processing is judged to be necessary in S2002 into the to-be-returned license data 1402 in the license return request 1400. It describes the information obtained in S2003 into the terminal information 800 in the license return request 1400.

S2005: Upon receipt of the license return request 1400 via the communication unit 311, the server-intended terminal information DB updating unit 310 obtains the terminal ID 404 and the terminal information 800 included in the request 1400, and records it into the server-intended terminal information DB 304.

S2006: Upon receipt of the license return request 1400 via the communication unit 311, the license data generation/updating unit 307 obtains the to-be-returned license data 1402 from the license return request 1400, and records it, as the user-owned license data 700, into the user-owned license DB 303. At that time, the license data generation/updating unit 307 sets the value specified in the user information DB 300 in the user ID 400 in the user-owned license data 700, using the terminal ID 404 in the license return request 1400. The value set in the subset use condition setting rule ID 501 in the user-owned license data 700 is the set value 601 of the subset use condition identified by the subset use condition setting rule ID 501 in the data in the use right DB 301 identified by the use right ID 502 in the to-be-returned license data 1402 in the license return request 1400. Here, as shown in FIG. 6, as the set value 601 of the subset use condition setting rule, the value for permitting the further use of the content is set based on the issue date of the license data 900, for example, “(date of license issue)˜(date of license issue+7 days)” or “1 time”. Therefore, the license data 900 which has been once invalidated by the subset use condition 901 is returned to the right management server 100, where the subset use condition 901 is updated by the license data generation/updating unit 307, and thus the invalidation of the license data 900 is cancelled. After completing the recording into the user-owned license DB 303, the license data generation/updating unit 307 notifies the user terminal 110 of the completion of the license return via the communication unit 311. This license return completion notification, which is not shown in the diagram, includes the license data 900 to be reissued, like the license return request 1400 as shown in FIG. 14. Therefore, the license data of which the subset use condition 901 is updated to a new value is reissued to the user terminal 110. The license data generation/updating unit 307 deletes, from the user-owned license DB 303, the user-owned license data 700 corresponding to the reissued license data 900. The license data 900 to be reissued does not always need to be transmitted to the user terminal 110 together with the license return completion notification. Instead, the user terminal 110 may obtain the license data 900 to be reissued, as the license necessary for reproduction of the content, from the right management server 100, separately from the license return completion notification.

S2007: When the user terminal 110 receives the license return completion notification via the communication unit 1014, the license return processing ends.

This is the end of the explanation of the operations performed when the user terminal 110 returns the license data 900 held in the license DB 1002.

The explanation of the present embodiment has been made on the assumption that the license returning unit 1007 deletes, from the terminal-intended terminal information DB 1003, the terminal information 800 which is transmitted when the license data 900 is returned, at the timing when obtaining it from the terminal-intended terminal information DB 1003 in S2003. However, the obtained terminal information 800 does not always need to be deleted from the terminal-intended terminal information DB 1003 at that timing. Instead, the user terminal 110 may delete the terminal information 800 after receiving the license return completion notification from the license data generation/updating unit 307 in S2006, for example.

In the present embodiment, this license return processing has been explained on the assumption that it is started when power is applied to the user terminal 110. However, the processing may be started according to predetermined date/time or frequency such as “at 12 o'clock every day” and “once a day”. The processing may also be started when the user terminal 110 performs a predetermined operation, for example, “after finishing the reproduction of the content”.

Next, the license return judgment process in S2001 of FIG. 20 will be explained with reference to the flowchart in FIG. 21. The license return judgment process is a process for judging whether the return processing of the license data 900 is necessary or not.

S2101: The license returning unit 1007 judges whether each of the license data 900 stored in the license DB 1002 should be returned or not with reference to the use condition 503 and the subset use condition 901. How to judge whether the license data 900 should be returned or not using the subset use condition 901 is explained as follows. In the case where the validity period is set in the subset use condition 901, the license returning unit 1007 judges that the license data 900 should be returned when the time point of the judgment is out of the validity period. In the case where the maximum number of reproductions is set in the subset use condition 901, it judges that the license data 900 should be returned when the maximum number is 0.

S2102: When the license returning unit 1007 judges in S2101 that there is the license data 900 which should be returned, it goes to the processing of S2103. When it judges that there is no license data 900 which should be returned, it goes to the processing of S2104.

S2103: The license returning unit 1007 judges that the license return processing is necessary.

S2104: The license returning unit 1007 judges that the license return processing is not necessary.

This is the end of the explanation of the license return judgment process.

This is the end of the explanation of the operations performed in the digital content distribution system in the present embodiment.

The license data which is distributed from the right management server 100 to the user terminal 110 may be the license data 2200 as shown in FIG. 22 in such a format that the number of reproductions 2201 is added to the license data 900. The number of reproductions 2201 is the information indicating the number of actual reproductions of a content. The default value thereof is 0, and 1 is added on every reproduction of the content. In the license data 2200, the maximum number of reproductions 505 indicates the upper limit for the permitted number of reproductions of the content, and thus means that the reproduction of the content is permitted when the number of reproductions 2201 is less than the maximum number of reproductions 505. In this case, the DB updating unit 1008 does not perform the processing of subtracting 1 from the maximum number of reproductions 505 when the content is reproduced. Instead, it shall perform the processing of adding 1 to the number of reproductions 2201 (i.e., the processing of S1807 in the flowchart of FIG. 18). The use condition judgment unit 1012 does not check whether the maximum number of reproductions 505 is 1 or more in the processing of judging whether the reproduction of the content is permitted or not. Instead, it shall check whether the number of reproductions 2201 is less than the maximum number of reproductions 505 or not (i.e., the processing of S1902 in the flowchart of FIG. 19). Note that the number of reproductions 2201 is not always be added to the license data 2200 when it is distributed from the right management server 100 to the user terminal 110, but may be added on the user terminal 110 after it is distributed there.

In the present embodiment, the subset use condition setting rule ID 501 is set in the data held in the use right DB 301 as shown in FIG. 5. But instead, the subset use condition 901 which is to be set in the license data 900 may be set. Likewise, instead of the subset use condition setting rule ID 501 in the user-owned license data 700 as shown in FIG. 7, the subset use condition 901 which is to be set in the license data 900 may be set. In this case, the processing of S1604 in FIG. 16 is omitted, and the processing goes to S1605 after S1603.

In the present embodiment, the subset use condition 901 is set during the processing of S1704 in FIG. 17 based on the comparison with the validity period 506 or the maximum number of reproductions 505 in the license data 900. However, as the subset use condition 901, the value calculated in S1704 may be set in the case where the subset use condition type 600 is the validity period, and the set value itself of the data may be set in the case where the subset use condition type 600 is the maximum number of reproductions.

This is the end of the explanation of the embodiment of the present invention.

As described above, according to the present invention, both the use condition 503 and the subset use condition 901 are described in one license data 900, so the subset use condition 901 can be issued at the same time when the license data 900 is issued. To be more specific, in the case where the user terminal 110 usually reproduces the content off-line, the user is likely to turn off the user terminal or remove the modular cable while he/she is not using the terminal. Therefore, in order to access the user terminal 110 for the server's reasons under such conditions, the server has to previously make an agreement on the access timing with the user terminal, and hold and manage the agreed-upon timing. In addition, since the server usually has to hold the agreed-upon timing for each user, it has to manage an enormous amount of data. As just described, it is difficult for the server to establish the communication network with the user terminal 110 at an arbitrary timing, unless the user terminal 110 requests access to the server. On the other hand, the present invention allows the server to issue the license data 900 to which the subset use condition 901 is added even in the above case, so the server can transmit the subset use condition 901 via the previously established communication network upon receipt of the license issue request from the user terminal 110. This is the effect of the present invention.

In addition, according to the present invention, the server does not subdivide the use condition based on the use right purchased by the user so as to issue the licenses thereof separately, but transmits a set of them as single license data 900 to the user terminal 110. Therefore, the server does not need to make additional management of the license data 900, such as calculation of the rest of the use right after subtracting the portion issued as license from the purchased use right, holding of the balance of the use right, and update of its value. In other words, all the server has to do is to hold the ID of the issued license data 900 and the subset use condition setting rule and to update the subset use condition 901 in the returned license data 900 when it is reissued. As a result, the processing load on the server for managing the use right purchased by the user can be reduced. Furthermore, since the server does not subdivide the use condition so as to issue the licenses thereof separately, an amount of the license data which should be managed by the server can be reduced, and the server does not need to manage the license data which has already issued to the user terminal.

### INDUSTRIAL APPLICABILITY

The user terminal of the present invention is of value as a content reproduction apparatus with a communication function, a personal computer, a personal digital assistant (PDA), a mobile phone, a set top box (STB) or the like. The right management server of the present invention is of value as a server for distributing a license for allowing use of a content to the user terminal via a communication network such as a broadcasting network and the Internet, and collecting terminal information from the user terminal that uses the content particularly in an off-line environment. The digital content distribution system of the present invention is of value as a content using system in which the right management server distributes a license of a digital content such as video and music to the user terminal via a communication network such as a broadcasting network and the Internet, and the user terminal uses the digital content based on the distributed license, particularly as a content using system or the like in which the user terminal uses the content in an off-line environment.

1. A digital content distribution system comprising a right management server and a user terminal which are connected to each other via a communication network, said right management server issuing, to the user terminal, license information for permitting a user to use a content, and said user terminal using the content based on the license information obtained from the right management server,
wherein the right management server includes:
a first condition generation unit operable to generate a first condition based on a content use right owned by the user, said first condition being a condition for permitting the user to use the content;
a second condition generation unit operable to generate a second condition that indicates a part or all of the use permitted under the first condition and indicates whether the license information is valid or invalid based on a logical product of the first condition and said second condition;
a license generation unit operable to generate the license information including the first condition and the second condition in response to a license obtainment request from the user terminal; and
a license issuance unit operable to issue the generated license information to the user terminal so that said user terminal obtains said license information, and
the user terminal includes:
a license obtainment requesting unit operable to request the right management server to issue the license information so as to obtain said license information;
an invalidity judgment unit operable to judge whether the license information is invalid or not based on the first condition and the second condition included in the obtained license information; and
a using unit operable to provide the use of the content to the user when it is judged that the license information is not invalid.

2. The digital content distribution system according to claim 1,
wherein the user terminal further includes a license information returning unit operable to return the license information to the right management server when it is judged that the license information is invalid, and
the right management server further includes:
a return acceptance unit operable to accept, from the user terminal, return of the license information which is judged to be invalid;
an invalidation cancellation unit operable to cancel invalidation of the license information by updating the second condition included in the returned license information to a new value; and
a reissuance unit operable to reissue, to the user terminal, the license information of which invalidation is cancelled.

3. The digital content distribution system according to claim 2,
wherein the user terminal further includes a history information storage unit operable to generate history information indicating a history of the use of the content when said content is used by the using unit, and store the generated history information, and
the license information returning unit transmits the license information to be returned, together with the stored history information, to the right management server.

4. The digital content distribution system according to claim 3,
wherein the second condition is represented by a maximum allowable number of uses of the content which is counted when said content is used after a date when the license information is issued.

5. The digital content distribution system according to claim 3,
wherein the second condition is represented by an expiry date of a validity period of the content which starts on a date when the license information is issued.

6. The digital content distribution system according to claim 3,
wherein the second condition is represented by a subset of the first condition, said subset being either a maximum allowable number of uses which is not more than a maximum allowable number of uses indicated in the first condition or an expiry date which is earlier than an expiry date indicated in the first condition.

7. The digital content distribution system according to claim 2,
wherein the invalidity judgment unit judges whether the license information is invalid or not based on the updated second condition included in the reissued license information.

8. The digital content distribution system according to claim 1,
wherein the using unit includes a condition updating unit operable to update each of the first condition and the second condition to a new value obtained by subtracting a value of the use right which is consumed under the provision of the use, every time the content is used.

9. The digital content distribution system according to claim 1,
wherein the license information includes an item of a usage amount into which the number of actual uses of the content is recorded with a default value being 0, when the content is used based on the license information,
the invalidity judgment unit judges whether the license information is invalid or not by comparing between a value of the second condition and a value of the item of the usage amount, both of which are included in said license information, and
the using unit includes a usage amount calculation unit operable to increment the number of actual uses recorded in the item of the usage amount by an amount of an actual use, every time the content is used.

10. The digital content distribution system according to claim 1,
wherein the license information includes at least a license information ID for identifying the license information, the first condition, the second condition and a content decryption key for decrypting an encrypted content which is permitted to be used based on the license information.

11. The digital content distribution system according to claim 1,
wherein the second condition generation unit includes a rule storage unit operable to previously store a rule for generating the second condition, and
the second condition generation unit generates the second condition according to the rule stored in the rule storage unit.

12. The digital content distribution system according to claim 11,
wherein the rule is defined for each use right of each content, and
the second condition generation unit generates the second condition for each license information according to the rule.

13. The digital content distribution system according to claim 11,
wherein the rule is defined uniformly for any use right, and
the second condition generation unit generates the second condition uniformly for any license information according to the rule.

14. The digital content distribution system according to claim 1,
wherein the invalidity judgment unit judges whether the license information is invalid or not every time power is applied to the user terminal.

15. The digital content distribution system according to claim 14,
wherein the invalidity judgment unit judges that the license information is invalid when the maximum allowable number of uses in the second condition is 0.

16. The digital content distribution system according to claim 14,
wherein the invalidity judgment unit judges that the license information is invalid when a value of an item of a usage amount included in said license information is not less than a value of the second condition, said usage amount being an item into which the number of actual uses of the content is recorded with a default value being 0 when the content is used based on the license information.

17. A right management server connected with a user terminal via a communication network for issuing license information to the user terminal so that the user terminal obtains the license information, said license information permitting a user to use a content, said server comprising:
a first condition generation unit operable to generate a first condition based on a content use right owned by the user, said first condition being a condition for permitting the user to use the content;
a second condition generation unit operable to generate a second condition that indicates a part or all of the use permitted under the first condition and indicates whether the license information is valid or invalid based on a logical product of the first condition and said second condition;
a license generation unit operable to generate the license information including the first condition and the second condition in response to a license obtainment request from the user terminal; and
a license issuance unit operable to issue the generated license information to the user terminal so that said user terminal obtains said license information.

18. The right management server according to claim 17, further comprising:
a return acceptance unit operable to accept, from the user terminal, return of the license information which is judged to be invalid;
an invalidation cancellation unit operable to cancel invalidation of the license information by updating the second condition included in the returned license information to a new value; and
a reissuance unit operable to reissue, to the user terminal, the license information of which invalidation is cancelled.

19. The right management server according to claim 18,
wherein the second condition generation unit includes a rule storage unit operable to previously store a rule for generating the second condition, and
the second condition generation unit generates the second condition according to the rule stored in the rule storage unit.

20. The right management server according to claim 19,
wherein the rule is defined for each use right of each content, and
the second condition generation unit generates the second condition for each license information according to the rule.

21. The right management server according to claim 19,
wherein the rule is defined uniformly for any use right, and
the second condition generation unit generates the second condition uniformly for any license information according to the rule.

22. A user terminal connected with a right management server via a communication network for obtaining license information from the right management server and using a content based on the obtained license information, said license information permitting a user to use the content, said terminal comprising:
a license obtainment requesting unit operable to request the right management server to issue the license information so as to obtain said license information;
an invalidity judgment unit operable to judge whether the license information is invalid or not based on a first condition and a second condition included in the obtained license information, said first condition being a condition for permitting the user to use the content based on a content use right owned by the user, said second condition indicating a part or all of the use permitted under the first condition and indicating whether the license information is valid or invalid based on a logical product of the first condition and said second condition;
a using unit operable to provide the use of the content to the user when it is judged that the license information is not invalid; and
a license information returning unit operable to return the license information to the right management server when it is judged that the license information is invalid.

23. The user terminal according to claim 22,
wherein the using unit includes a condition updating unit operable to update each of the first condition and the second condition to a new value obtained by subtracting a value of the use right which is consumed under the provision of the use, every time the content is used.

24. The user terminal according to claim 22,
wherein the license information includes an item of a usage amount into which the number of actual uses of the content is recorded with a default value being 0, when the content is used based on the license information,
the invalidity judgment unit judges whether the license information is invalid or not by comparing between a value of the second condition and a value of the item of the usage amount, both of which are included in said license information, and
the using unit includes a usage amount calculation unit operable to increment the number of actual uses recorded in the item of the usage amount by an amount of an actual use, every time the content is used.

25. The user terminal according to claim 22,
wherein the invalidity judgment unit judges whether the license information is invalid or not based on the second condition included in the license information, said second condition having been updated by the right management server, said license information having been returned and reissued.

26. The user terminal according to claim 22,
wherein the invalidity judgment unit judges whether the license information is invalid or not every time power is applied to the user terminal.

27. A right management method in a right management server connected with a user terminal via a communication network for issuing license information to the user terminal so that the user terminal obtains the license information, said license information permitting a user to use a content, said right management method comprising:
a first condition generation step of generating a first condition based on a content use right owned by the user, said first condition being a condition for permitting the user to use the content;
a second condition generation step of generating a second condition that indicates a part or all of the use permitted under the first condition and indicates whether the license information is valid or invalid based on a logical product of the first condition and said second condition;
a license generation step of generating the license information including the first condition and the second condition in response to a license obtainment request from the user terminal;
a license issuance step of issuing the generated license information to the user terminal so that said user terminal obtains said license information;
a return acceptance step of accepting, from the user terminal, return of the license information which is judged to be invalid;
an invalidation cancellation step of canceling invalidation of the license information by updating the second condition included in the returned license information to a new value; and
a reissuance step of reissuing, to the user terminal, the license information of which invalidation is cancelled.

28. A content using method in a user terminal connected with a right management server via a communication network for obtaining license information from the right management server and using a content based on the obtained license information, said license information permitting a user to use the content, said content using method comprising:
a license obtainment requesting step of requesting the right management server to issue the license information so as to obtain said license information;
an invalidity judgment step of judging whether the license information is invalid or not based on a first condition and a second condition included in the license information, said first condition being a condition for permitting the user to use the content based on a content use right owned by the user, said second condition indicating a part or all of the use permitted under the first condition and indicating whether the license information is valid or invalid based on a logical product of the first condition and said second condition;
a using step of providing the use of the content to the user when it is judged that the license information is not invalid; and
a license information returning step of returning the license information to the right management server when it is judged that the license information is invalid.

29. A program for a right management server connected with a user terminal via a communication network for issuing license information to the user terminal so that the user terminal obtains the license information, said license information permitting a user to use a content, said program causing a computer to execute:
a first condition generation step of generating a first condition based on a content use right owned by the user, said first condition being a condition for permitting the user to use the content;
a second condition generation step of generating a second condition that indicates a part or all of the use permitted under the first condition and indicates whether the license information is valid or invalid based on a logical product of the first condition and said second condition;
a license generation step of generating the license information including the first condition and the second condition in response to a license obtainment request from the user terminal;
a license issuance step of issuing the generated license information to the user terminal so that said user terminal obtains said license information;
a return acceptance step of accepting, from the user terminal, return of the license information which is judged to be invalid;
an invalidation cancellation step of canceling invalidation of the license information by updating the second condition included in the returned license information to a new value; and
a reissuance step of reissuing, to the user terminal, the license information of which invalidation is cancelled.

30. A program for a user terminal connected with a right management server via a communication network for obtaining license information from the right management server and using a content based on the obtained license information, said license information permitting a user to use the content, said program causing a computer to execute:
a license obtainment requesting step of requesting the right management server to issue the license information so as to obtain said license information;
an invalidity judgment step of judging whether the license information is invalid or not based on a first condition and a second condition included in the license information, said first condition being a condition for permitting the user to use the content based on a content use right owned by the user, said second condition indicating a part or all of the use permitted under the first condition and indicating whether the license information is valid or invalid based on a logical product of the first condition and said second condition;
a using step of providing the use of the content to the user when it is judged that the license information is not invalid; and
a license information returning step of returning the license information to the right management server when it is judged that the license information is invalid.
